(19) United States
(12) Patent Application Publication
(10) Pub. No.: US 2016/0203684 A1
(43) Pub. Date: Jul. 14, 2016

(54) Vibrating Device for Use with Monitor System

(71) Applicant: Liran JACOBI, Ramat Gan (IL)

(72) Inventor: Liran JACOBI, Ramat Gan (IL)

(21) Appl. No.: 14/595,450

(22) Filed: Jan. 13, 2015

(51) Int. Cl. G08B 6/00; G08B 21/02

(52) U.S. Cl. CPC G08B 6/00; G08B 21/0202

(57) ABSTRACT

A device includes a receiver for communicating with a monitor system and a vibrator. The receiver receives input from the monitor system over a network. A processing unit in communication with the receiver converts the received input to a signal and actuates the vibrator to vibrate at a vibration intensity upon the signal being above a threshold.

### TECHNICAL FIELD The present invention relates to monitor systems.

### BACKGROUND OF THE INVENTION

Monitor systems are typically used to monitor activity in a given location from a remote location. For example, baby monitor systems are typically used by caregivers to monitor the condition of babies or young children. A baby monitor system typically includes a transmitter unit in proximity to the child for capturing audio emitted by the child, and a receiver unit in proximity to the caregiver. Some baby monitor systems broadcast the sounds from the transmitter unit to the receiver unit. This allows the caregiver to monitor a crying baby without being in the same room as the baby. Baby monitors are particularly useful for monitoring babies at night. In such cases, the sound of a crying baby is broadcast to the receiver unit, alerting the caregiver. However, such baby monitor devices can wake up more than one person. In a two-parent home where the parents share a bedroom, both parents would awaken even though only one parent is required to care for the baby.

### SUMMARY OF THE INVENTION

The present invention is a device and corresponding components for providing a vibrating functionality with a monitor system.

According to the teachings of an embodiment of the present invention there is provided, a device comprising: (a) a receiver for communicating with a monitor system and a vibrator, the receiver configured for receiving input from the monitor system over a network; and (b) a processing unit n communication with the receiver for converting the received input to a signal and actuating the vibrator to vibrate at a vibration intensity upon the signal being above a threshold level.

According to a further feature of an embodiment of the present invention, the processing unit comprises: (i) a converter for converting the received input to the signal; and (ii) a processor programmed to analyze the signal.

According to a further feature of an embodiment of the present invention, the device further comprises: (a) a vibrating unit comprising at least one vibrator configured to vibrate at a vibration intensity when actuated by the processing unit.

According to a further feature of an embodiment of the present invention, the device further comprises: (a) a housing unit for housing the receiver, the processing unit, and the vibrating unit.

According to a further feature of an embodiment of the present invention, the housing unit is wearable.

According to a further feature of an embodiment of the present invention, the wearable housing unit is selected from the group consisting of: a waist belt, a wrist bracelet, and an ankle bracelet.

According to a further feature of an embodiment of the present invention, the device further comprises: (a) a vibration intensity adjustment associated with the vibrating unit for modifying the vibration intensity.

According to a further feature of an embodiment of the present invention, the vibration intensity adjustment is a user adjustable vibration intensity adjustment.

According to a further feature of an embodiment of the present invention, the device further comprises: (a) a user controlled vibrating unit actuator associated with the vibrating unit for actuating the vibrator to vibrate at a vibration intensity.

According to a further feature of an embodiment of the present invention, the device further comprises: (a) a power supply deployed to provide power to the receiver, the processing unit, and the vibrator.

According to a further feature of an embodiment of the present invention, the power supply is a direct current (DC) power supply configured to supply voltage of no more than 12 volts DC.

According to a further feature of an embodiment of the present invention, the power supply is a rechargeable power supply.

According to a further feature of an embodiment of the present invention, the network is a wireless network.

According to a further feature of an embodiment of the present invention, the wireless network is a Bluetooth connection.

According to a further feature of an embodiment of the present invention, the signal is an analog signal.

According to a further feature of an embodiment of the present invention, the monitor system is a baby monitor system.

According to a further feature of an embodiment of the present invention, the input is an audio signal.

According to a further feature of an embodiment of the present invention, the threshold level is a user adjustable threshold level.

According to a further feature of an embodiment of the present invention, the device further comprises: (a) a connector connected to the monitor system and the receiver, and the network is a wired network.

According to a further feature of an embodiment of the present invention, the device further comprises: (a) a monitor system for providing the input to the receiver over a network, the monitor system comprising: (i) a first unit for capturing audio and transmitting the captured audio; and (ii) a second unit for receiving the transmitted audio and generating the input based on the received audio.

### BRIEF DESCRIPTION OF THE DRAWINGS

The invention is herein described, by way of example only, with reference to the accompanying drawings, wherein:

FIG. 1A is an overall block diagram of a vibrating device in communication with a monitor system according to an embodiment of the invention;

FIG. 1B is an overall block diagram of a vibrating device in communication with mobile communication devices running application software for providing a monitor system functionality according to an embodiment of the invention;

FIGS. 2A-2C are schematic diagrams of a wearable housing unit according to embodiments of the invention;

FIG. 3 shows a wireless receiver according to an embodiment of the invention;

FIG. 4 illustrates a process for actuating a vibrating unit according to an embodiment of the invention;

FIG. 5 is a block diagram of a receiver in wired communication with a monitor system according to an embodiment of the invention.

### DESCRIPTION OF THE PREFERRED EMBODIMENTS

The present invention is a device and corresponding components for providing a vibrating functionality with a monitor system.

The principles and operation of a device and corresponding components according to the present invention may be better understood with reference to the drawings and the accompanying description. Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention is applicable to various types of monitor systems, and is of particular value when applied to mobile communication devices, such as smartphones, tablets, laptops, and the like, configured to function as a baby monitor system. in such a configuration, a first mobile communication device operates as the transmitter unit and performs the functions of capturing audio emitted from the child and subsequently broadcasting the captured audio. A second mobile communication device operates as the receiver unit for receiving the broadcast audio and subsequently emitting the captured audio via a speaker. The mobile communication devices typically communicate with each other wirelessly, via cellular (GPRS, 3G, 4G/LTE), WLAN (IEEE 802.11 standard Wi-Fi), Bluetooth, or any other suitable communication paradigm. The baby monitor system functionality of mobile communication devices may be facilitated by use of a software application or the like running on at least one of the mobile communication devices, such as an iOS iPhone/iPad or Android operating system device. Although the examples provided in the description herein are with regard to baby monitor systems, the potential applications of the present invention should not be limited to the applications used for the purposes of illustrating the principles and operation of a device and corresponding components according to the present invention, and can be used with monitor systems for alternative uses, such as security and surveillance systems and the like.

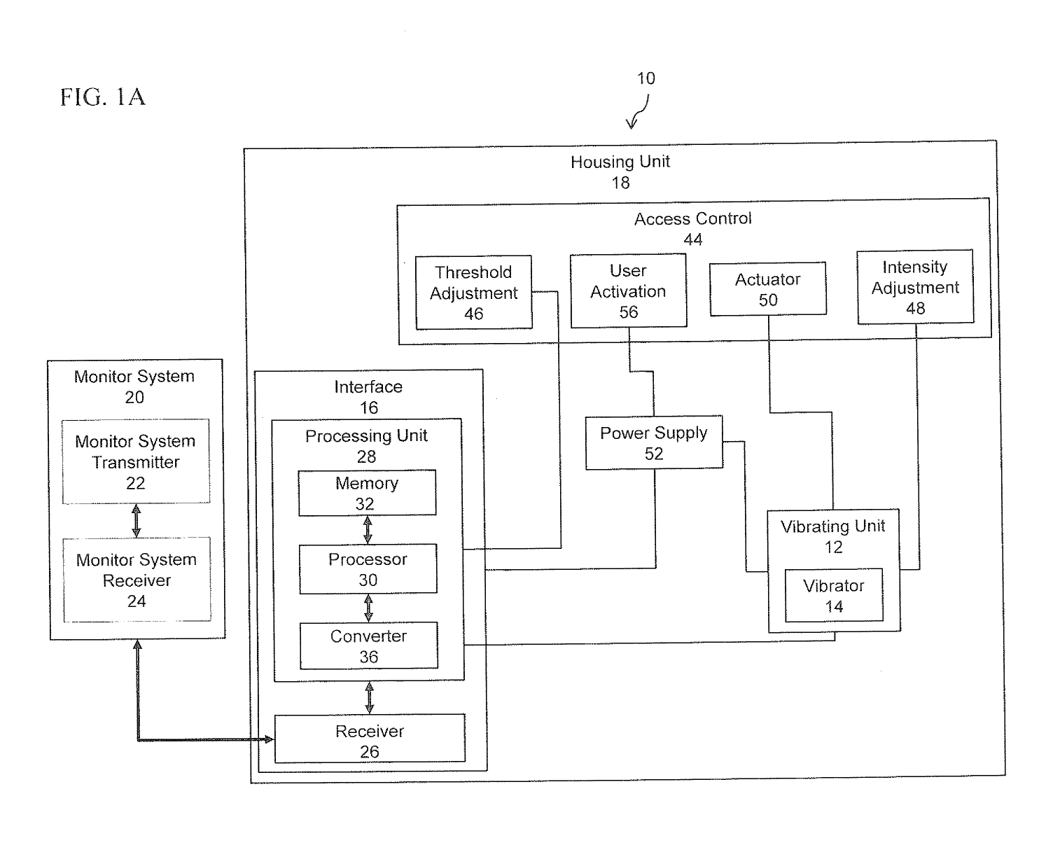

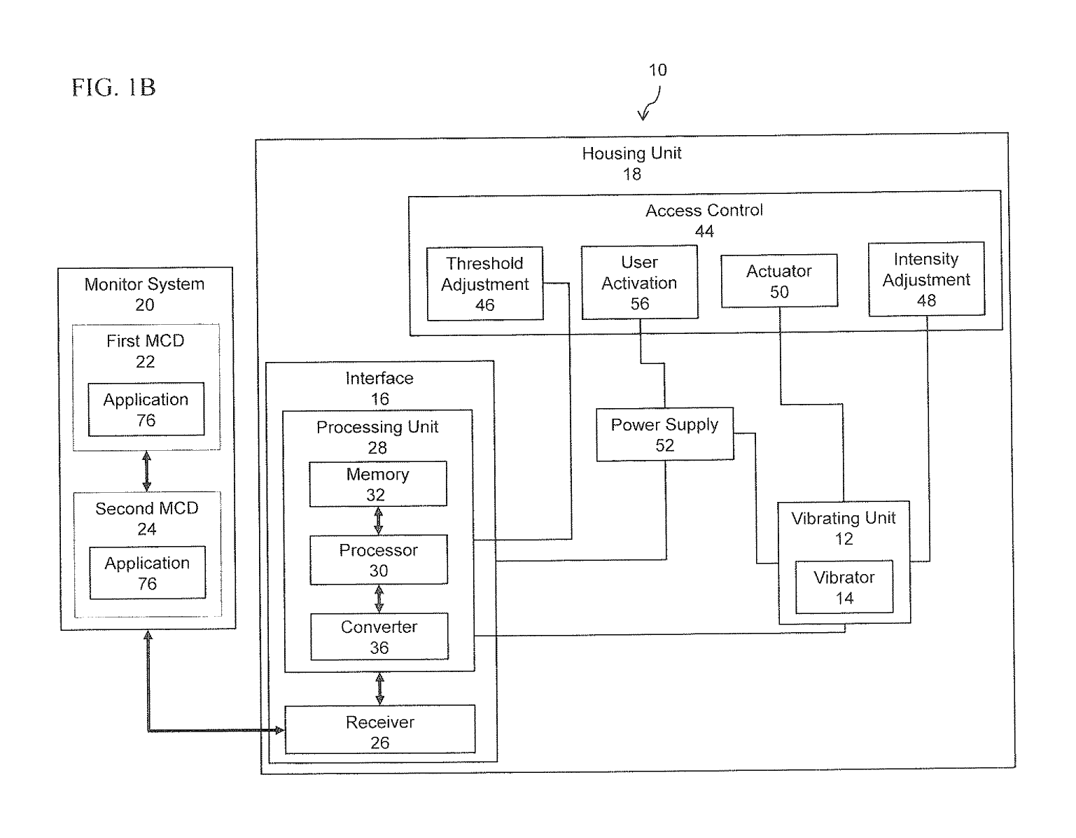

Referring now to the drawings, FIG. 1A is an overall block diagram of a device 10 and corresponding components for providing a vibrating functionality with a monitor system, for example a baby monitor system. With reference to FIG. 1A, major elements of device 10 preferably include a vibrating unit 12 with at least one vibrator 14, an interface unit 16 for receiving input from a monitor system 20 and processing the received input, a power supply 52 for providing power to vibrating unit 14 and interface unit 16, and a housing unit 18. Housing unit 18 is configured for simultaneously housing vibrating unit 12, interface unit 16, and power supply 52.

For the purposes of this document, power supplies and devices operating on voltages of no more than 12 volts direct current (DC) are termed “low voltage”, while power supplies of at least 100 volts alternating current (AC) are defined as “mains voltage power supply”. In more specific terms, a mains voltage power supply in the United States typically supplies power in the range of 100-120 volts AC, while a mains voltage power supply in Europe typically supplies power in the range of 220-240 volts AC. It is preferred that power supply 52 is a battery of low voltage. Power supply 52 may be implemented as a rechargeable battery with a maximum voltage of 12 volts DC. in such an implementation, a charging arrangement, in electrical communication with a mains voltage power supply, may be configured to come into operative cooperation with rechargeable power supply 52 via a charging interface. Types of charging arrangements may include, but are not limited to, charging cables, electrical contacts, and other suitable connections. It is preferred that the charging arrangement includes a voltage converter for converting the electricity supplied by mains voltage from AC electricity to DC electricity in order to supply rechargeable power supply 52. It is preferred that device 10 is configured to operate when charging arrangement is in operative cooperation with rechargeable power supply 52. This provides the user with continued use of device 10 while the rechargeable battery is charging.

It is preferred that a user activation mechanism 56 is electrically connected to power supply 52. User activation mechanism 56 may be in the form of a dial or switch and the like, and is preferably operable between an “on” or “activated” position, in which power is supplied to interface unit 16 and vibrating unit 12, and an “off” or “deactivated” position, in which power is not supplied to interface unit 16 and vibrating unit 12.

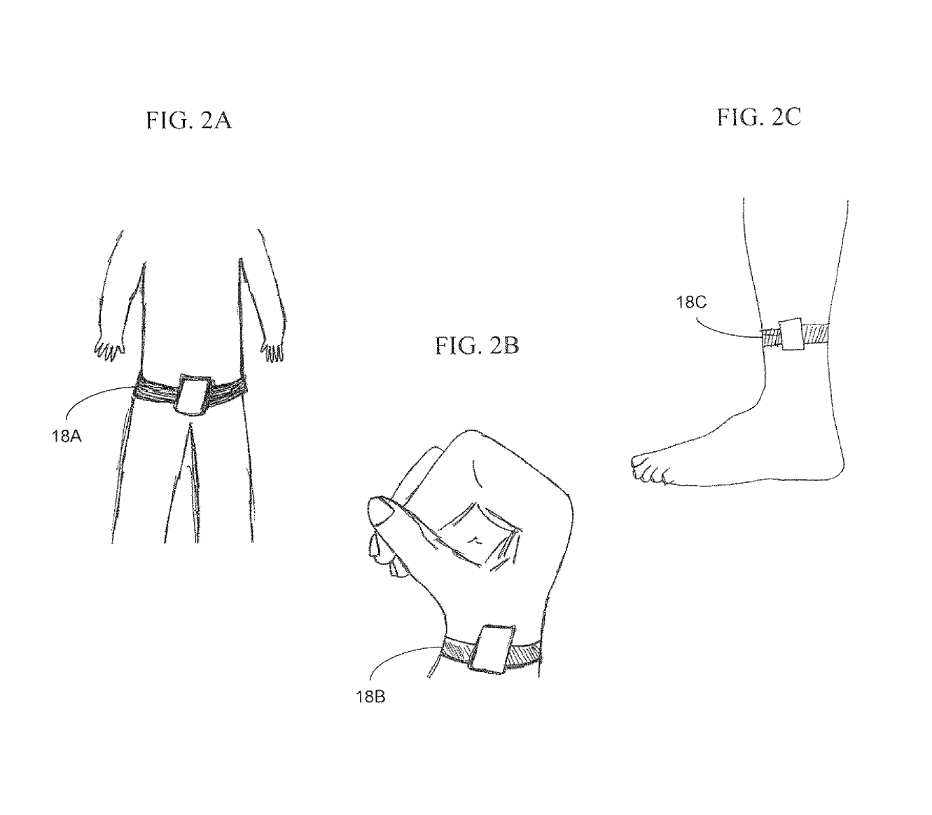

It is preferred that housing unit 18 is implemented as a structure that is wearable by a user (i.e. caregiver), allowing for the user to feel the vibration of vibrator 14. Housing unit 18 may be affixed to the user by suitable construction of housing unit 18. Non-limiting examples of such constructions are shown in FIGS. 2A-2C, where housing unit 18 is constructed as a belt 18A, a wrist bracelet 18B, and an ankle bracelet 18C. In these examples, it is preferred that the fitting of belt 18A, wrist bracelet 18B, and ankle bracelet 18C are adjustable so they can be worn by users of different sizes, resulting in a snug fit in which the user can feel the vibration from vibrating unit 12 against the skin. It is most preferable that belt 18A, wrist bracelet 18B, and ankle bracelet 18C are sized to be worn by adult human males and females. In such wearable implementations, additional electronic and/or mechanical functionality may be included as part of housing 18 to provide supplementary features to the user. For example, clock/watch functionality may be included when housing 18 is implemented as a wrist bracelet 18A (FIG. 2B). Such added functionality may be provided for aesthetic purposes, and may not necessarily affect the vibration functionality of device 10. It is noted that the examples depicted in FIGS. 2A-2C are for illustration purposes only, and many other wearable configurations are possible which vibration felt by the user. Furthermore, non-wearable options are also possible in which a user may position housing 18 in a location which results vibration from vibrating unit 12 being felt by the user, for example, under the user's pillow.

It is preferred that vibrator 14 is a vibration motor or equivalent, and is preferably of size suitable for being attached to wearable housing unit 18. In one non-limiting example, vibrator 14 is a coin type vibrator motor operable at low voltages, such as 5 volts DC or lower. The wearable functionality of housing unit 18 allows for a single caregiver to be alerted to the crying of the baby without alerting other caregivers as will be described.

In a particularly preferred but non-limiting implementation, the monitor system, from which device 10 is configured to receive input, includes first and second communication units 22 and 24. Most preferably, communication units 22 and 24 are mobile communication devices (MCD). Referring to FIG. 1B, first MCD 22 operates as the monitor system transmitter, and second MCD 24 operates as the monitor system receiver. As previously described, MCDs 22 and 24 may be configured to run application software 76 for providing a baby monitor system functionality. Preferably, first MCD 22 includes a microphone or the like for capturing audio. The application software 76 preferably configures first MCD 22 for transmission of audio signals and data, and second MCD 24 for reception and transmission of audio signals and data via a communication paradigm as previously mentioned. As previously described, first and second MCDs 22 and 24 may be smartphones, tablets, laptops, or any combination thereof. Interface unit 16 preferably includes a receiver 26 and a processing unit 28 electrically connected to receiver 26. Receiver 26 is preferably configured to receive input from second MCD 24 via a communication network. The received input may be in the form of the audio signal transmitted by first MCD 22, a signal corresponding to the audio signal generated by second MCD 24, or any other suitable input.

Processing unit 28 preferably contains conversion circuitry 36 electrically connected to a processor 30 coupled to a storage medium 32 such as a memory. Processor 30 can be any number of computer processors including, but not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions.

In implementations where second MCD 24 provides input to receiver 26 via a digital communication technique, conversion circuitry 36 is preferably a digital to analog converter (DAC) for converting digital output from receiver 26 to an output signal, notably an analog output signal. It should be apparent that various architectural implementations of receiver 26 and processing unit 28 are possible, and that in certain implementations, DAC 36 may be integrated as part of the architecture of receiver 26.

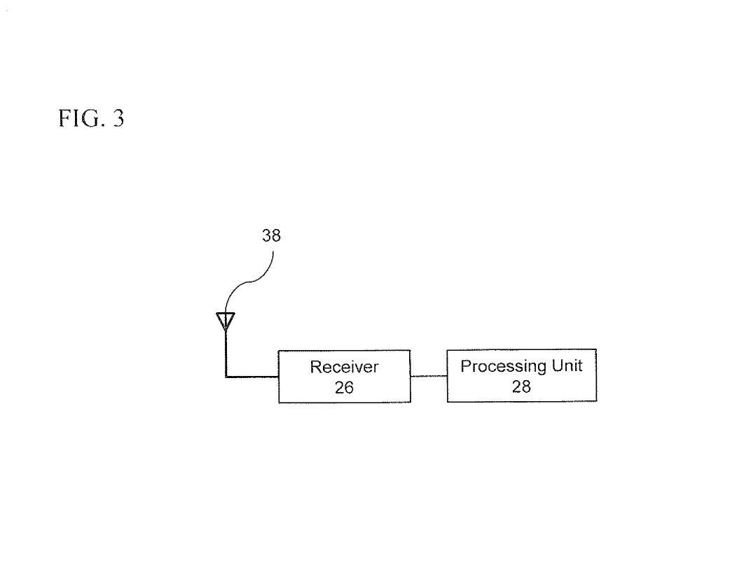

In one non-limiting implementation, upon receipt of an audio signal by second MCD 24, second MCD 24 transmits a corresponding signal which serves as input to receiver 26. In one non-limiting example, second MCD 24 is configured for broadcasting the corresponding signal. Although not depicted in the drawings, it should be understood that receiver 26 includes any necessary components for receiving signals, including, but not limited to, amplifiers, analog to digital converters (ADC), mixers, filters, local oscillators. and demodulators. As shown in FIG. 3, when receiver 26 is configured for wirelessly receiving signals, an antenna 38 is coupled to receiver 26. In practice, the audio signal received by MCD 24 may be digitized, and the corresponding signal may be a processed version of the digitized signal. In one non-limiting example, the corresponding signal may be a compressed and/or filtered version of the digitized audio signal. In another non-limiting example, the corresponding signal may be a forwarded copy of the audio signal. DAC 36 subsequently produces the output signal from the corresponding received signal. It is preferred that the characteristics, such as magnitude and phase, of the corresponding signal are proportional, if not equal to, the characteristics of the audio signal.

The processor 30 in processing unit 28 is programmed to analyze the output signal to determine if the output signal is above a threshold level. If the output signal is above the threshold level, processor 30 actuates vibrating unit 12 to vibrate vibrator 14 at a vibration intensity. Preferably, the threshold level is a function of at least one signal characteristic, such as the amplitude of the output signal. A device such as a discriminator or the like (not shown), electrically connected to processing unit 28, may be used for determining when the output signal is above the threshold level.

Since the output signal is a processed version of the audio signal, it is preferred that the threshold level necessary for producing vibration is similarly a function of the audio signal. For example, if processing unit 28 uses signal processing techniques which result in the output signal having amplitude which is half the amplitude of the audio signal, the factor of two is similarly incorporated into the threshold level. This means that a threshold of 50 dB corresponding to the audio signal would translate to a threshold level of approximately 47 dB corresponding to the output signal. It is noted that the amplitude of the audio signal corresponds to the sound level of the audio signal. It is therefore preferable that the threshold level be within the range of the sound level of a crying baby. Typically, a crying baby can produce sound in the range of approximately 50-120 decibels (dB).

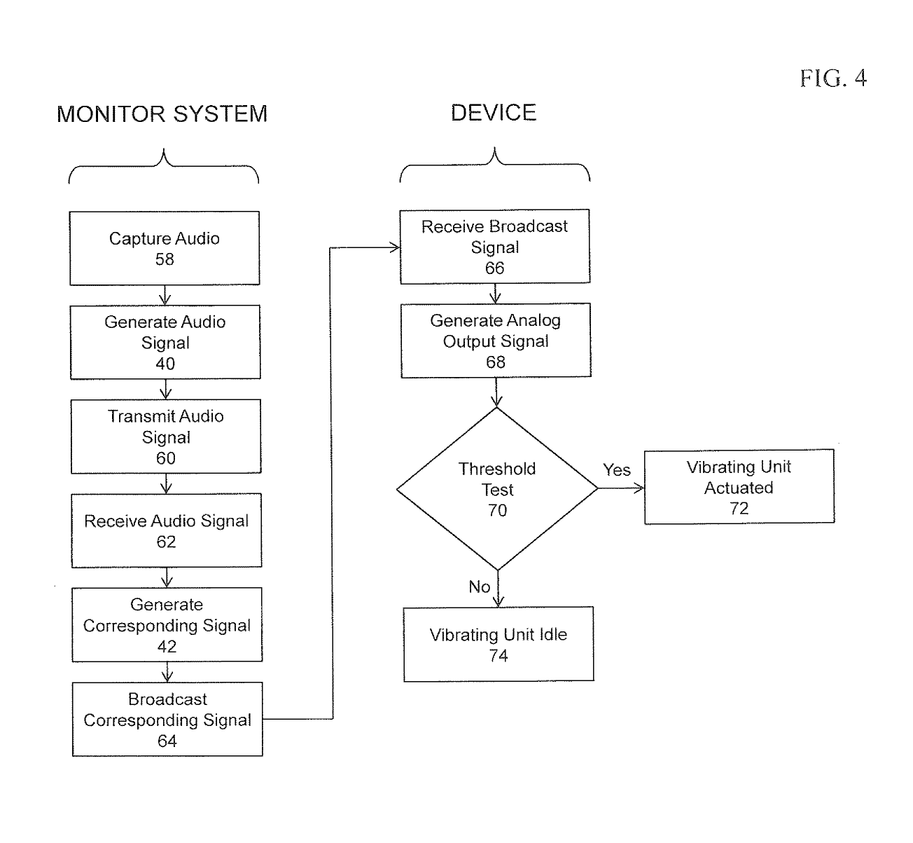

An example of the operation of device 10 will now be described. In operation, baby monitor system 20 is activated with first MCD 22 in proximity to the child and second MCD 24 in proximity to the user. The user wears housing 18, for example belt 18A, and activates device 10. The sound emission functionality of second MCD 24 is preferably disabled by the user. With reference to FIG. 4, subsequent to activation of device 10, audio emanating from the child is captured 58 by first MCD 22. First MCD 22 generates the audio signal 40, and transmits 60 audio signal 40 to second MCI) 24. Audio signal 40 is received 62 by second MCD 24, inducing second MCD 24 to generate the corresponding signal 42. Second MCD 24 subsequently broadcasts 64 corresponding signal 42 which is received 66 by receiver 26. DAC 36 subsequently generates (analog) output signal 68 by converting corresponding signal 42. The characteristics of the analog signal 68 are analyzed and evaluated against threshold level 70 by processor 30. When output signal 68 is above the threshold level, processor 30 actuates vibrating unit 12 to vibrate 72 vibrator 14 at a vibration intensity. The user, wearing housing unit 18, feels the vibration, thus alerting the user to the noise from the child. Because the sound from second MCD 24 is suppressed, only the user wearing housing unit 18 is alerted to the noise from the child. Vibrating unit 12 remains idle 74 if the output signal 68 is below the threshold level.

The noise level generated by children varies in range based on a multitude of factors. As such, it preferable for the threshold level which causes actuation of vibrating unit 12 to be adjustable. According to certain embodiments, device 10 includes a user threshold adjustment 46 for adjusting the threshold level. Threshold adjustment 46 may be an adjustable dial or switch electrically connected to processing unit 28. The user is not alerted by the vibration of vibrator 14 unless the specified characteristic of signal 42 (e.g. amplitude) is above the threshold set according to threshold adjustment 46. Preferably, when the threshold is selected by the user, the vibration intensity of vibrator 14 is a function of the characteristic level of signal 42, and correspondingly audio signal 40. For example, consider the case where the threshold level is set to 60 dB by the user. The vibration intensity associated with 70 dB audio of the child will be more intense than the vibration intensity associated with 60 dB audio of the child. In cases where the threshold is not set according to threshold adjustment 46 as defined by the user, the threshold is set to a device defined threshold, such as, for example, 50 dB.

User threshold adjustment 46 may be included as part of a user access control unit 44 which provides a user with control functionality over certain components of device 10. In addition to user threshold adjustment 46, user access control unit 44 may also include an intensity adjustment 48 for manually adjusting the vibration intensity of vibrator 14. Intensity adjustment may be an adjustable dial or switch electrically connected to vibrating unit 12. User access control unit 44 may further include a vibrating unit actuator 50 for providing the user with manual access for actuating vibrating unit 12 to vibrate vibrator 14. This functionality is typically used to verify the operation of vibrating unit 12 when baby monitor system 20 is not active. User access control unit 46 is preferably housed in housing unit 18. It is preferable that user access control unit 44 includes user activation mechanism 56.

According to certain embodiments, receiver 26 is configured for wireless receiving. In one particularly preferred but non-limiting implementation, receiver 26 is a Bluetooth receiver. Accordingly, MCD 24 is configured to transmit the corresponding signal 42 via a Bluetooth module in MCD 24. Bluetooth modules are commonplace in mobile communication devices. The receiver and DAC blocks of interface 16 may be combined when implementing communication via Bluetooth, depending on the specific Bluetooth receiver architecture implementation. When implementing receiver 26 for communication via Bluetooth, it is preferred that corresponding signal 42 is the audio signal 40 received by second MCD 24. While Bluetooth connectivity is the preferred wireless communication protocol, other protocols/techniques are possible, including, but not limited to, cellular (GPRS, 3G, 4G/LTE) and WLAN (IEEE 802.11). It is noted that peripheral hardware devices connected to second MCD 24 may further facilitate communication via such protocols. Furthermore, it is noted that certain communication protocols/techniques may not be conducive to the transmission of audio signals, and therefore, corresponding signal 42 may be a constructed non-audio signal which triggers vibrating unit 12 based on signal levels and threshold levels corresponding to audio signal 40 as previously described. It is also noted that such peripheral hardware devices may include a Bluetooth module for providing connectivity between second MCD 24 and device 10. In cases where second MCD 24 is a laptop running application software for providing a monitor system functionality, a peripheral hardware device may be electrically connected to second MCD 24 via a connector. Types of connectors include, but are not limited to, USB, FireWire, and any other data bus suitable for connecting peripheral devices.

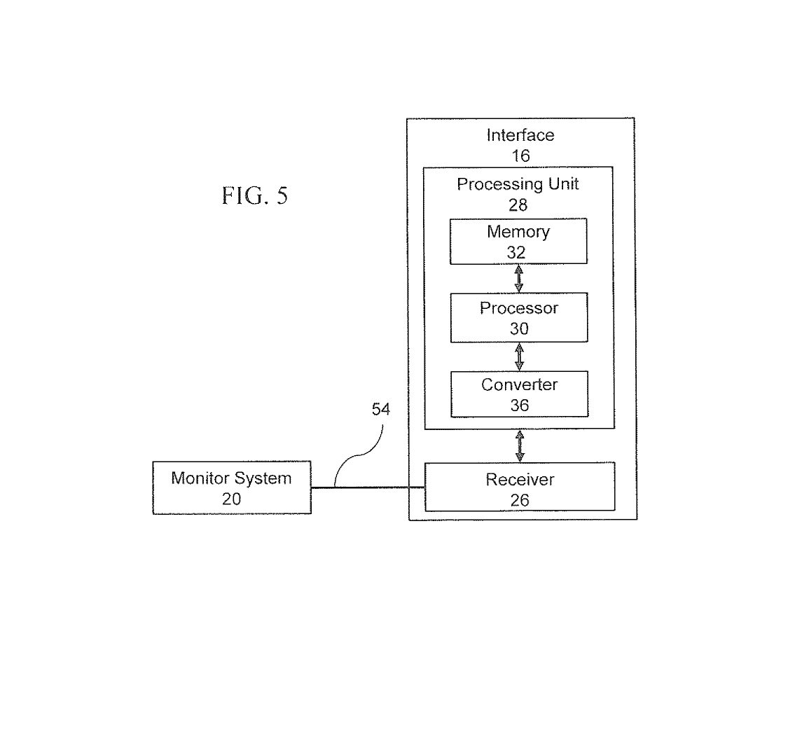

The wireless connectivity of second MCD 24 and interface 16 provides the user with the freedom to move about while wearing housing unit 18 without carrying second MCD 24. However, in certain situations, it may be preferable to have a physical wired connection between second MCD 24 and interface 16. According to certain embodiments, interface 16 receives corresponding signal 42 via a wired network. In such an embodiment, device 10 includes a connector 54 connected to MCD 24 and interface 16, as shown in FIG. 5. Connector 54 facilitates the communication of data between second MCD 24 and device 10 using any suitable data transmission scheme.

It is noted that the network over which first MCD 22 and second MCD 24 communicate, and the network over which second MCD 24 and device 10 communicate, may be different communications networks. For example, first MCD 22 and second MCD 24 may communicate over WLAN, while second MCD 24 and device 10 may communicate over Bluetooth.

Although the device as described thus far has pertained to operating with mobile communications devices with application software for providing a monitor system functionality, other embodiments are possible in which the device operates with traditional monitor systems using dedicated transmitter and receiver units communicating via RF or the like.

It will be appreciated that the above descriptions are intended only to serve as examples, and that many other embodiments are possible within the scope of the present invention as defined in the appended claims.

What is claimed is:

1. A device comprising:
(a) a receiver for communicating with a monitor system and a vibrator, the receiver configured for receiving input from the monitor system over a network; and
(b) a processing unit in communication with the receiver for converting the received input to a signal and actuating the vibrator to vibrate at a vibration intensity upon the signal being above a threshold level.

2. The device of claim 1, wherein the processing unit comprises:
(i) a converter for converting the received input to the signal; and
(ii) a processor programmed to analyze the signal.

3. The device of claim 1, further comprising:
(a) a vibrating unit comprising at least one vibrator configured to vibrate at a vibration intensity when actuated by the processing unit.

4. The device of claim 3, further comprising:
(a) a housing unit for housing the receiver, the processing unit, and the vibrating unit.

5. The device of claim 4, wherein the housing unit is wearable.

6. The device of claim 5, wherein the wearable housing unit is selected from the group consisting of: a waist belt, a wrist bracelet, and an ankle bracelet.

7. The device of claim 3, further comprising:
(a) a vibration intensity adjustment associated with the vibrating unit for modifying the vibration intensity.

8. The device of claim 7, wherein the vibration intensity adjustment is a user adjustable vibration intensity adjustment.

9. The device of claim 3, further comprising:
(a) a user controlled vibrating unit actuator associated with the vibrating unit for actuating the vibrator to vibrate at a vibration intensity.

10. The device of claim 1, further comprising:
(a) a power supply deployed to provide power to the receiver, the processing unit, and the vibrator.

11. The device of claim 10, wherein the power supply is a direct current (DC) power supply configured to supply voltage of no more than 12 volts DC.

12. The device of claim 10, wherein the power supply is a rechargeable power supply.

13. The device of claim 1, wherein the network is a wireless network.

14. The device of claim 13, wherein the wireless network is a Bluetooth connection.

15. The device of claim 1, wherein the signal is an analog signal.

16. The device of claim 1, wherein the monitor system is a baby monitor system.

17. The device of claim 1, wherein the input is an audio signal.

18. The device of claim 1, wherein the threshold level is a user adjustable threshold level.

19. The device of claim 1, further comprising:
(a) a connector connected to the monitor system and the receiver, and wherein the network is a wired network.

20. The device of claim 1, further comprising:
(a) a monitor system for providing the input to the receiver over a network, the monitor system comprising:
(i) a first unit for capturing audio and transmitting the captured audio; and
(ii) a second unit for receiving the transmitted audio and generating the input based on the received audio.
